(19) United States
(12) Patent Application Publication
(10) Pub. No.: US 2012/0024967 A1
(43) Pub. Date: Feb. 2, 2012

(54) QR CODE AND MANUFACTURING METHOD THEREOF

(75) Inventor: YU-HSIANG CHEN, Tu Cheng (TW)

(73) Assignee: Cheng Uei Precision Industry Co., LTD., Tu Cheng City (TW)

(21) Appl. No.: 12/849,001

(22) Filed: Aug. 2, 2010

(51) Int. Cl. G06K 19/06; B22D 17/00; B23K 26/00

(52) U.S. Cl. 235/494; 219/121.69; 164/48

(57) ABSTRACT

Disclosed is a QR (Quick Response) code. The QR code is a square block composed of message unit blocks arranged without gaps according to a predetermined rule. The message unit blocks include black blocks and white blocks. The white message unit blocks of the QR code are bright planes formed on a metal surface through die casting. Each bright plane of white message unit block is set at an identical inclination angle with respect to a horizontal plane. The black message unit blocks of the QR code are formed as scattering planes on the metal surface and are set on an identical plane parallel to the horizontal plane. The QR code is highly stable, readable and identifiable. A method for manufacturing the QR code is also provided.

### TECHNICAL FIELD OF THE INVENTION

The present invention relates to a two-dimension barcode, and especially to a QR (Quick Response) code formed on a metal surface and a manufacturing method thereof.

### BACKGROUND OF THE INVENTION

A two-dimension barcode is a new technology of information storage and transmission, which is widely used in various applications, including product identification, security and anti-counterfeiting, and E-commerce. The two-dimension barcode records information data with specific geometric patterns of black and white graphic symbols arranged in two-dimensional directions. The concept of logical basis of “0” and “1” bit stream adopted in computer systems is utilized to form graphic symbols that correspond to binary representation of text and numerical information. The graphic symbols can be read by an image input device or a photoelectric scanning device to achieve automatic information processing.

International standards of the two-dimension barcode include for example PDF417, Data Matrix, Maxi Code, and QR (Quick Response) Code, among which QR code is most widely used. The QR code shows an advantage of high-speed and all-direction (360 degrees) accessibility, and is capable of representation of Chinese characters, rendering QR code wide applicability in various fields. The QR code comprises a square array of a series of small square message blocks, in which “0” or “1” are represented through variation of gray levels of bright and dark blocks. For applications automobile manufacturing, aircraft manufacturing, weapon manufacturing, and various mechanical products, the QR code must be formed via engraving a metal surface or a plastic surface. However, the QR code formed through engraving leads to a contrast between bright and dark blocks that is poorer than a contrast obtained in a printed surface. This makes the identification of QR code on a metal surface difficult, eventually resulting in distortion of identified data.

Therefore, it is desired to have a highly stable, readable and identifiable QR code to overcome aforesaid drawbacks.

### SUMMARY OF THE INVENTION

An objective of the present invention is to provide a highly stable, readable, and identifiable QR (Quick Response) code.

Another objective of the present invention is to provide a manufacturing method of a QR code which is highly stable, readable and identifiable.

To achieve the foregoing objectives, according to an aspect of the present invention, a QR code is provided, comprising a square block composed of a plurality of message unit blocks arranged according to certain rules without gaps. The message unit blocks comprise white and black message unit blocks. The white message unit blocks of the QR code are bright planes formed on a metal surface through die casting, and each bright plane of white message unit block is set at an angle with respect to a horizontal plane. The black message unit blocks of the QR code are scattering planes formed on the metal surface, and the scattering planes are set on the same plane parallel to the horizontal plane.

According to another aspect, the present invention provides a manufacturing method of QR code, comprising the following first and second steps, of which the first step performs die casting on a metal surface to form bright planes corresponding to message unit blocks that constitute the QR code, the bright plane of each of the message unit blocks being set at an identical inclination angle with respect to a horizontal plane, and the second step uses a laser engraving machine to remove one or more of the bright planes that correspond to black message unit blocks of the QR code to respectively form scattering planes that are set on the same plane parallel to the horizontal plane.

Accordingly, the QR code of the present invention represents black and white message unit blocks respectively through the bright planes and the scattering planes, which show an enhanced contrast between bright and dark, so that the QR code so formed is of high stability, readability and identification.

### BRIEF DESCRIPTION OF THE DRAWINGS

FIG. 1 is a schematic view illustrating a QR code according to the present invention.

FIG. 2 is a schematic view showing a structure of white message unit block that is represented as a bright plane of the QR code of FIG. 1.

FIG. 3 is a schematic view showing a structure of black message unit block that is represented as a scattering plane of the QR code of FIG. 1.

FIG. 4 is a flow chart illustrating a manufacturing method of the QR code according to the present invention.

### DETAILED DESCRIPTION OF THE INVENTION

Reference will now be made in detail to the present preferred embodiments of the invention, examples of which are illustrated in the accompanying drawings.

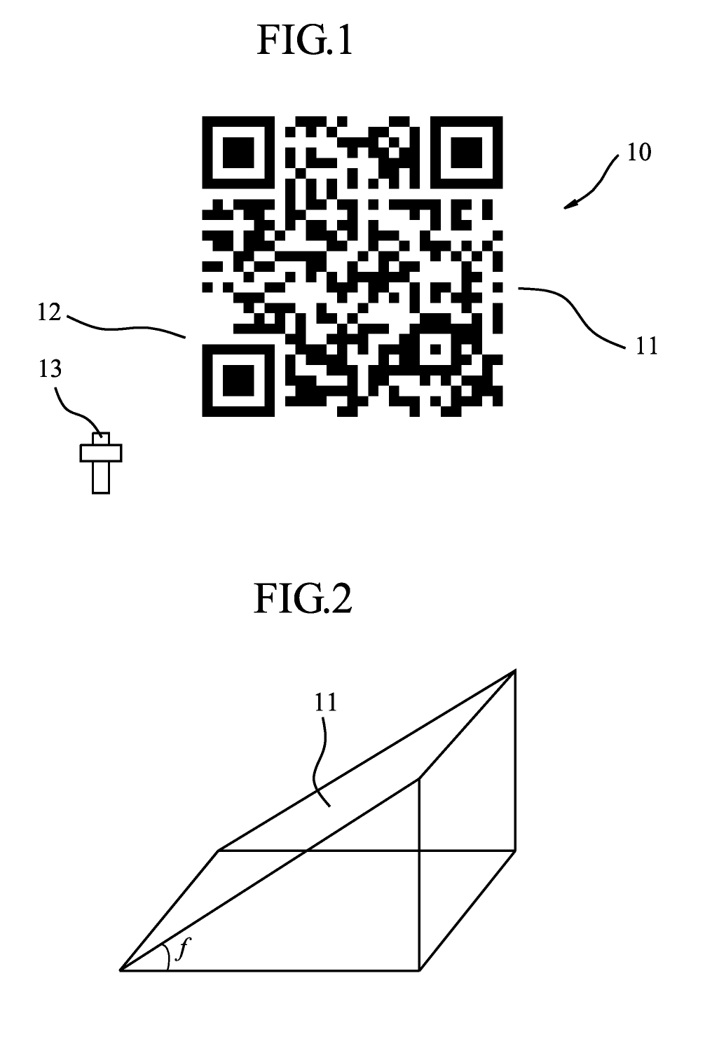

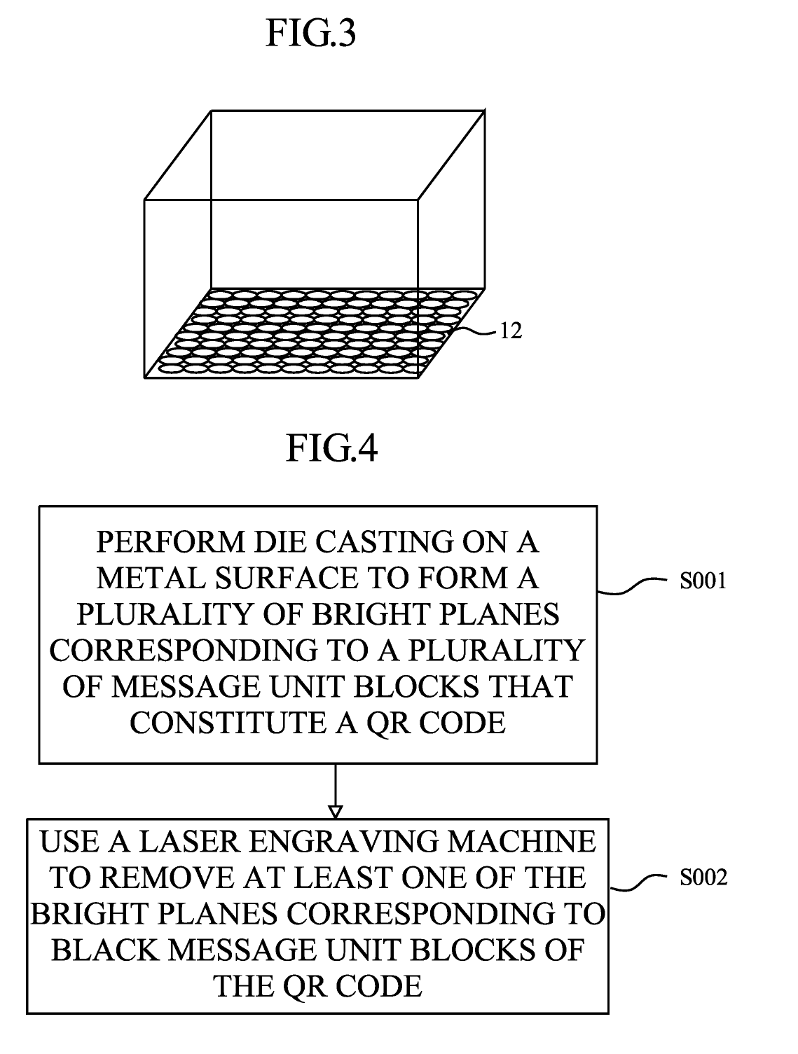

With reference to the drawings and in particular to FIGS. 1-3, a QR code according to the present invention, generally designated at 10, is applicable to formation on a metal surface or a plastic surface. The QR code 10 is a square block composed of a plurality of message unit blocks, which is square, arranged without gaps according to certain rules. The message unit blocks include white and black blocks respectively representing different binary values. In accordance with one preferred embodiment of the present invention, the white message unit blocks of the QR code 10 are represented as bright planes 11 formed on a metal surface through die casting. The bright planes 11 of the white message unit blocks are set at an inclination angle φ with respect to a horizontal plane. Preferably, the angle φ is between 0 and 45 degrees.

The black message unit blocks of the QR code 10 are represented as scattering planes 12 in accordance with one preferred embodiment of the present invention. The scattering planes 12 are formed on the same plane, which is parallel to the horizontal plane. With the white and black message unit blocks of the QR code 10 represented as bright planes 11 and scattering planes 12, the contrast therebetween is enhanced and readability and stability are improved.

Reference is now made to FIG. 4 for illustrating a manufacturing method of the QR code 10. The method of FIG. 4 begins at step S001.

At step S001, die casting is performed to form bright planes on a metal surface respectively corresponding to message unit blocks that constitute the QR code, which the bright planes of the message unit blocks are set at an identical inclination angle with respect to a horizontal plane.

At step S002, a laser engraving machine is used to remove one or more of the bright planes corresponding to positions of black message unit blocks of the QR code to form scattering planes that are set on the same plane parallel to the horizontal plane.

Specifically, the manufacturing method further comprises a step of forming a positioning block 13 through die casting in front of the step S001, wherein the QR code 10 is formed on one side of said positioning block 13 with edges of the QR code 10 respectively perpendicular to edges of the positioning block 13. As being indicated by the positioning block 13, bright planes 11 of can be easily formed on a metal surface with identical inclination through die casting, the laser engraving machine may easily acquire position information of the QR code 10 to accurately and quickly remove the bright planes 11 corresponding to the black message unit blocks of the QR code 10 for forming desired scattering planes 12.

As mentioned above, the QR code 10 of the present invent presents the white and black message unit blocks via the bright planes and the scattering planes with a strong contrast induced therebetween, so that the QR code 10 so formed shows high stability, readability and easy identification.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A QR (Quick Response) code, which is in the form of a square, comprising a plurality of message unit blocks arranged without gaps according to a predetermined rule, the message unit blocks comprise white and black blocks;
wherein the white message unit blocks of the QR code comprise bright planes that are formed on a metal surface through die casting, each of the bright planes of the white message unit blocks being set at an identical inclination angle with respect to a horizontal plane; and
wherein the black message unit blocks of the QR code comprise scattering planes formed on the metal surface and set on an identical plane parallel to the horizontal plane.

2. A manufacturing method of a QR (Quick Response) code, comprising the following steps:
a first step of performing die casting on a metal surface to form a plurality of bright planes corresponding to a plurality of message unit blocks that constitute a QR code, each of the bright planes of the message unit blocks being set at an identical inclination angle with respect to a horizontal plane; and
a second step of using a laser engraving machine to remove at least one of the bright planes corresponding to positions of black message unit blocks of the QR code to form at least one scattering plane set on a plane parallel to the horizontal plane.

3. The method as claimed in claim 2, further comprising a step of forming a positioning block through die casting in front of the first step, wherein the QR code is formed on one side of the positioning block with edges of the QR code respectively perpendicular to edges of the positioning block.
